(19) United States
(12) Patent Application Publication
(10) Pub. No.: US 2023/0176158 A1
(43) Pub. Date: Jun. 8, 2023

(54) Micro-electromechanical Systems (MEMS) Directional Acoustic Sensors for Underwater Operation

(71) Applicant: THE UNITED STATES OF AMERICA, AS REPRESENTED BY THE SECRETARY OF THE NAVY, Arlington, VA (US)

(72) Inventors: Gamani KARUNASIRI, Pacific Grove, CA (US); Fabio Durante Pereira ALVES, Marina, CA (US)

(21) Appl. No.: 17/496,674

(22) Filed: Oct. 7, 2021

Related U.S. Application Data
(60) Provisional application No. 63/088,845, filed on Oct. 7, 2020.

(51) Int. Cl. G01S 3/801

(52) U.S. Cl. CPC G01S 3/801

(57) ABSTRACT

A microelectromechanical system configured to be submerged in a fluid having an acoustic sensor assembly having a substrate, interdigitated comb finger capacitors, one or more sensor, a boot assembly a boot assembly having a cavity being configured to contain dielectric fluid and to enclose the acoustic sensor assembly, where the acoustic sensor assembly is communicably coupled to the dielectric fluid and boot, the acoustic sensor assembly being configured to receive the one or more sound waves from a source through the boot and dielectric fluid with near unity acoustic transmission, and a flange assembly disposed at a top side of the boot assembly and configured to cover and seal the acoustic sensor assembly and the dielectric fluid in the boot assembly.

### CROSS-REFERENCE

This Application is a nonprovisional application of and claims the benefit of priority under 35 U.S.C. § 119 based on U.S. Provisional Patent Application No. 63/088,845 filed on Oct. 7, 2020. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Research and Sponsored Programs Office, Halligan Hall, Room 230, Naval Postgraduate School, Monterey, Calif. 93943-5138, referencing NPS Case No. 20200010.

### TECHNICAL FIELD

The present disclosure is related to microelectromechanical systems (MEMS)-based directional acoustic sensors operating in an underwater environment, and more specifically to (but not limited to) one or more winged sensors that may be coupled to a substrate and optimally operate in a frequency band based on the resonant frequency associated with the structure.

### BACKGROUND

The bearing of underwater sound sources is typically obtained using a linear array of omnidirectional hydrophones spaced proportionally to the wavelength of the source to be located. See Lasky, M., Review of World War I Acoustic Technology. U.S. NAVY J. Underw. Acoust. 1974, 24, 363-385. These arrays require time delay, amplitude difference, or phase-weighting algorithms to determine the direction of the detected sound. See Ziomek, L. J.; Sonar Systems Engineering; Taylor & Francis Group: Boca Raton, Fla., USA, 2017. These sensors have evolved over the years, from relatively heavy and complex systems that required significant space onboard ships to thin light linear arrays easily handled by relatively small autonomous platforms. See Pallayil, V., Chitre, M. A., Deshpande; P. A. Digital Thin Line Towed Array for Small Autonomous Underwater Platforms. In Proceedings of the Oceans 2007, Vancouver, BC, Canada, 29 Sep.-4 Oct. 2007. See Maguer, A.; Dymond, R.; Mazzi, M.; Biagini, S.; Fioravanti, S.; Guerrini, P. SLITA: A new Slim Towed Array for AUV applications. In Proceedings of the Acoustics, Paris, France, 30 Jun.-4 Jul. 2008. An alternative approach is the use of vector sensors, which are designed to acquire vector quantities associated with the sound field. See Ehrlich, S. L. L., Frelich, P. D.; Sonar Transducer. U.S. Pat. No. 3,290,646, 6 Dec. 1966. See Ehrlich, S. L., Serotta, N., Kleinschmidt, K.; Multimode ceramic transducers. J. Acoust. Soc. Am. 1959, 31, 854. [CrossRef]. See Aronov; B. S. Calculation of first-order cylindrical piezoceramic receivers. Sov. Phys. Acoust. 1988, 34, 466-470. See Beranek, L. L., Mellow, T. J. Acoustics Sound Fields and Transducers; Elsevier: Oxford, UK, 2012. See Edalatfar, F.; Azimi, S.; Qureshi, A.; Yaghootkar, A.; Keast, A.; Friedrich, W.; Leung, A.; Bahreyni, B.; A Wideband, Low noise Accelerometer for Sonar Wave Detection; IEEE Sens. J. 2017, 18, 508-516. [CrossRef]. See Dymond, R.; Sapienza, A.; Troiano, L.; Guerrini, P.; Maguer, A. New vector sensor design and calibration measurements. In Proceedings of the Fourth International Conference of Underwater Acoustic Measurements: Technologies and Results, Kos Island, Greece, 20-24 Jun. 2011. See Akal, T.; de Bree, H. E.; Gur, B. Hydroflown based low frequency underwater acoustical receiver. In Proceedings of the 4th Interenet Conference & Exhibition In Underwater Acoustics Measurements: Technologies & results, Kos Island, Greece, 20-24 Jun. 2011; pp. 871-878.

A common method to determine the direction of sound is the measurement of pressure gradient. See Beranek, L. L., Mellow, T. J. Acoustics Sound Fields and Transducers; Elsevier: Oxford, UK, 2012, or particle velocity due to the volumetric motion of the medium. See Edalatfar, F.; Azimi, S.; Qureshi, A.; Yaghootkar, A.; Keast, A.; Friedrich, W.; Leung, A.; Bahreyni, B.; A Wideband, Low Noise Accelerometer for Sonar Wave Detection; IEEE Sens. J. 2017, 18, 508-516. These variables carry the directional information of the acoustic energy propagation, which helps to identify the direction of the source. Multiple other techniques have been studied and combined to produce a directional response from underwater acoustic sensors. These include a combination of omnidirectional hydrophones to measure the pressure and an accelerometer to acquire particle velocity See Dymond, R.; Sapienza, A.; Troiano, L.; Guerrini, P.; Maguer, A. New vector sensor design and calibration measurements. In Proceedings of the Fourth International Conference of Underwater Acoustic Measurements: Technologies and Results, Kos Island, Greece, 20-24 Jun. 2011. Commercially available vector sensors use different techniques. For example, the Microflown vector sensor measures the particle velocity by means of the temperature difference between two parallel platinum hot-wire resistors. See Akal, T.; de Bree, H. E.; Gur, B. Hydroflown based low frequency underwater acoustical receiver. In Proceedings of the 4th Interenet Conference & Exhibition In Underwater Acoustics Measurements: Technologies & results, Kos Island, Greece, 20-24 Jun. 2011; pp. 871-878. The Wilcoxon vector sensor uses three lead magnesium niobate-lead titanate (PMN-PT) crystal-based axial accelerometers and a lead zirconate titanate (PZT) omnidirectional hydrophone to extract directionality. See Shipps, C. J.; Deng, K. A miniature vector sensor for line array applications. In Proceedings of the Oceans 2003, Celebrating the Past Teaming Toward the Future, San Diego, Calif., USA, 22-26 Sep. 2003. See Shipps, C. J.; Abraham, B. M. The Use of Vector Sensors for Underwater Port and Waterway Security. In Proceedings of the Sensors for Industry Conference, New Orleans, La., USA, 27-29 Jan. 2004; pp. 41-44.

The measurement of particle velocity using neutrally buoyant objects that are displaced by the incident acoustic wave was also explored. See Leslie, C. B.; Kendall, J. M.; Jones, J. Hydrophone for Measuring Particle Velocity. J. Acoust. Soc. Am. 1956, 28, 711-715. [CrossRef]. These sensors were constructed by mounting a velocity-sensitive device inside a rigid shell. Id. The common characteristic of these sensors is the figure eight directivity pattern. More recently, there have been efforts to develop bio-inspired hydrophones using micromechanical structures. One of the biological systems mimicked is the lateral line tube organ of a fish. The sensor uses a pair of long cantilever beams with piezoresistors, which deform depending on the direction and pressure of the incident wave, inducing a resistance variation of the beams. See Guan, L.; Zhang, G.; Xu, J.; Xue, C.; Zhang, W.; Xiong, J. Design of T-shape vector hydrophone based on MEMS. In Proceedings of the 16th International Solid-State Sensors, Actuators and Microsystems Conference, Beijing, China, 5-9 Jun. 2011. A bionic vector sensor was also explored using a solitary vertical cylinder that rests in the center of two crossed beams fabricated using microelectromechanical systems (MEMS) technology. Acoustic waves incident to the solitary vertical cylinder create compressive and tensile stresses in the structure. These stresses are transduced to a voltage by the piezoresistive effect of resonant tunneling diodes. See Xue, C.; Tong, Z.; Zhang, B.; Zhang, W. A Novel Vector Hydrophone Based on the Piezoresistive Effect of Resonant Tunneling Diode. IEEE Sens. J. 2008, 8, 401-402. [CrossRef].

A previous patent of the current inventors, U.S. Pat. No. 9,843,858, which is hereby incorporated by reference in its entirety, relates to bio-inspired MEMS directional sound sensors that operate in air based on the hearing system of the Ormia Ochracea parasitic fly. See Miles, R. N.; Rober, D.; Hoy, R. R. Mechanically coupled ears for directional hearing in the parasitoid fly Ormia Ochracea. Acoust. Soc. Am. 1995, 98, 3059-3069. [CrossRef] [PubMed]. One advantage of the sensors described in U.S. Pat. No. 9,843,858 includes the ability to determine the direction of a sound with sensors having a size much smaller than the wavelength of the detected sound. In that patent, a sensor can include two wings that are coupled by a bridge and attached to a substrate using two torsional legs. The sensors can be built using MEMS technology on a silicon-on-insulator (SOI) substrate with integrated comb finger capacitors attached to the outer edge of the wings for electronic readout of the wings' vibration under sound excitation. See Touse, M.; Sinibaldi, J.; Simsek, K.; Catterlin, J.; Harrison, S.; Karunasiri, G. Fabrication of a microelectromechanical directional sound sensor with electronic readout using comb fingers. Appl. Phys. Lett. 2010, 96, 173701. [CrossRef]. See Downey, R. H.; Karunasiri, G. Reduced residual stress curvature and branched comb fingers increase sensitivity of MEMS acoustic sensor. J. Microelectromechanical Syst. 2014, 23, 417-423. [CrossRef]. The mechanical structure has two predominant oscillatory modes, rocking and bending, with frequencies depending on the dimensions of the structure and stiffness of the material employed. It was previously found that the bending motion of the wings has a larger amplitude and has a cosine dependence to the incident direction of sound when operated with both front and back sides exposed to sound. See Touse, M.; Sinibaldi, J.; Simsek, K.; Catterlin, J.; Harrison, S.; Karunasiri, G. Fabrication of a microelectromechanical directional sound sensor with electronic readout using comb fingers. Appl. Phys. Lett. 2010, 96, 173701. [CrossRef].

While the aforementioned sensors provide accurate operation in air, there exists a need for a solution to address the need to accurately detect the direction of sound in underwater applications. In particular, there exists a need for a device and method for MEMS directional acoustic sensors operating in an underwater environment.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present disclosure provides for MEMS-based directional sound sensors with multiple different configurations for application in an underwater environment. Two sensors were designed using finite element modeling (COMSOL Multiphysics®) and their frequency and directional responses in air and immersed silicone oil surrounded by water were simulated. The sensors were fabricated using the MEMS commercial foundry MEMSCAP® and fully characterized in air. A close agreement between prediction and measurement in an anechoic chamber was obtained. A housing was designed for testing the sensor in underwater environment and the materials employed were found to exhibit nearly 100% acoustic transmission. The measured resonant peaks of the two sensors were close to that of the simulations, while the directional responses showed the expected dipole behavior associated with pressure gradient microphones. Noise measurement of the sensor with readout electronics gave a signal to noise ratio of about 22 dB at 1 Pa incident sound pressure. These results indicate that the disclosed MEMS directional acoustic sensors can be used for underwater applications, especially in resonant mode, which can be tuned by design.

The present disclosure provides for a microelectromechanical system configured to be submerged in a fluid. In some embodiments, the system may include a substrate, a first plurality of fixed comb finger capacitors coupled to the substrate at a first end of the substrate and extending along a width of the first end of the substrate, and a second plurality of fixed comb finger capacitors coupled to the substrate at a second end of the substrate and extending along a width of the second end of the substrate. The system may include a first sensor wing and a second sensor wing coupled to the first sensor wing by a bridge assembly attached to the substrate. The system may include a first plurality of movable comb finger capacitors extending along a width of a first end of the first sensor wing, the first plurality of fixed comb finger capacitors and the first plurality of movable comb finger capacitors being a first set of interdigitated comb finger capacitors, and a second plurality of movable comb finger capacitors extending along a width of a second end of the second sensor wing, the second plurality of fixed comb finger capacitors and the second plurality of movable comb finger capacitors being a second set of interdigitated comb finger capacitors. The system may include a boot assembly having a cavity being configured to contain dielectric fluid and to enclose the acoustic sensor assembly, wherein the acoustic sensor assembly is communicably coupled to the dielectric fluid and boot, the acoustic sensor assembly being configured to receive the one or more sound waves from a source through the boot and dielectric fluid with near unity acoustic transmission, and a flange assembly disposed at a top side of the boot assembly and configured to cover and seal the acoustic sensor assembly and the dielectric fluid in the boot assembly.

In some embodiments, the system may include an acoustic sensor assembly having a substrate, a first plurality of fixed comb finger capacitors coupled to the substrate at a first end of the substrate and extending along a width of the first end of the substrate, and a first sensor body and a first plurality of movable comb finger capacitors extending along a width of a first end of the first sensor body, the first sensor body being coupled to the substrate at a pivot point surface, the first plurality of fixed comb finger capacitors and the first plurality of movable comb finger capacitors being a set of interdigitated comb finger capacitors, wherein the first sensor body is configured to pivot about the pivot point surface responsive one or more sound waves incident on a first surface of the first sensor body, wherein the pivoting causes the set of interdigitated comb finger capacitors to generate an electrical signal based on an amount of pivoting associated with the first sensor body. The system may include a boot assembly having a housing and a cavity formed in the housing and being configured to contain dielectric fluid and to enclose the acoustic sensor assembly, the substrate, and the set of interdigitated comb finger capacitors, wherein the acoustic sensor assembly is communicably coupled to the dielectric fluid and the housing, the acoustic sensor assembly being configured to receive the one or more sound waves from a source through the housing and the dielectric fluid with near unity acoustic transmission. The system may include a flange assembly disposed at a top side of the boot assembly and configured to cover and seal the acoustic sensor assembly and the dielectric fluid in the boot assembly, wherein the acoustic sensor assembly is configured to generate the electrical signal with (1) a maximum frequency response in a frequency band based around a resonant frequency associated with the acoustic sensor assembly and (2) a cosine dependent directional response.

The present disclosure provides for a method of operating a microelectromechanical system configured to be submerged in a fluid comprising. The method may include providing an acoustic sensor assembly, the acoustic sensor assembly comprising: a substrate; a first plurality of fixed comb finger capacitors coupled to the substrate at a first end of the substrate and extending along a width of the first end of the substrate; a second plurality of fixed comb finger capacitors coupled to the substrate at a second end of the substrate and extending along a width of the second end of the substrate; a first sensor wing; a second sensor wing coupled to the first sensor wing by a bridge assembly attached to the substrate; a first plurality of movable comb finger capacitors extending along a width of a first end of the first sensor wing, the first plurality of fixed comb finger capacitors and the first plurality of movable comb finger capacitors being a first set of interdigitated comb finger capacitors; and a second plurality of movable comb finger capacitors extending along a width of a second end of the second sensor wing, the second plurality of fixed comb finger capacitors and the second plurality of movable comb finger capacitors being a second set of interdigitated comb finger capacitors. The method may include providing a boot assembly having a cavity being configured to contain dielectric fluid and to enclose the acoustic sensor assembly, wherein the acoustic sensor assembly is communicably coupled to the dielectric fluid and boot, the acoustic sensor assembly being configured to receive the one or more sound waves from a source through the boot and dielectric fluid with near unity acoustic transmission. The method may include providing a flange assembly disposed at a top side of the boot assembly and configured to cover and seal the acoustic sensor assembly and the dielectric fluid in the boot assembly; and receiving, by the acoustic sensor assembly, the one or more sound waves from the source through the boot and dielectric fluid with near unity acoustic transmission.

### BRIEF DESCRIPTION OF THE DRAWINGS

FIG. 1 is schematic of an exemplary embodiment of an acoustic sensor assembly, in accordance with disclosed aspects.

FIG. 2 is schematic of an SEM micrograph exemplary embodiment of an acoustic sensor assembly, in accordance with disclosed aspects.

FIG. 3 is a schematic of various views an exemplary embodiment of a microelectromechanical system, in accordance with disclosed aspects.

FIGS. 4a, 4b, and 4c are images of exemplary embodiments of a microelectromechanical system, in accordance with disclosed aspects.

FIGS. 5a and 5b are exemplary embodiments of response plots of simulated frequency (FIG. 5a) and directional (FIG. 5b) responses of a microelectromechanical system, in accordance with disclosed aspects.

FIGS. 6a and 6b are exemplary embodiments of response plots of measured frequency (FIG. 6a) and directional (FIG. 6b) responses of a microelectromechanical system, in accordance with disclosed aspects.

FIG. 7 is a schematic of an exemplary embodiment of a calibration system having a reference hydrophone, in accordance with disclosed aspects.

FIG. 8 is a plot of the signal measured from an exemplary embodiment of a calibration system having a reference hydrophone, in accordance with disclosed aspects.

FIG. 9 is a plot of frequency responses of different thicknesses used for a housing of a PMC-780 polyurethane boot assembly, in accordance with disclosed aspects.

FIG. 10 is schematic of an exemplary embodiment of an acoustic sensor assembly, in accordance with disclosed aspects.

FIG. 11 is schematic of an SEM micrograph exemplary embodiment of an acoustic sensor assembly, in accordance with disclosed aspects.

FIGS. 12a and 12b are exemplary embodiments of response plots of simulated frequency (FIG. 12a) and directional (FIG. 12b) responses of a microelectromechanical system, in accordance with disclosed aspects.

FIGS. 13a and 13b are exemplary embodiments of response plots of measured frequency (FIG. 13a) and directional (FIG. 13b) responses of a microelectromechanical system, in accordance with disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present disclosure provides for embodiments of a microelectromechanical system configured to be submerged in a fluid and operation thereof.

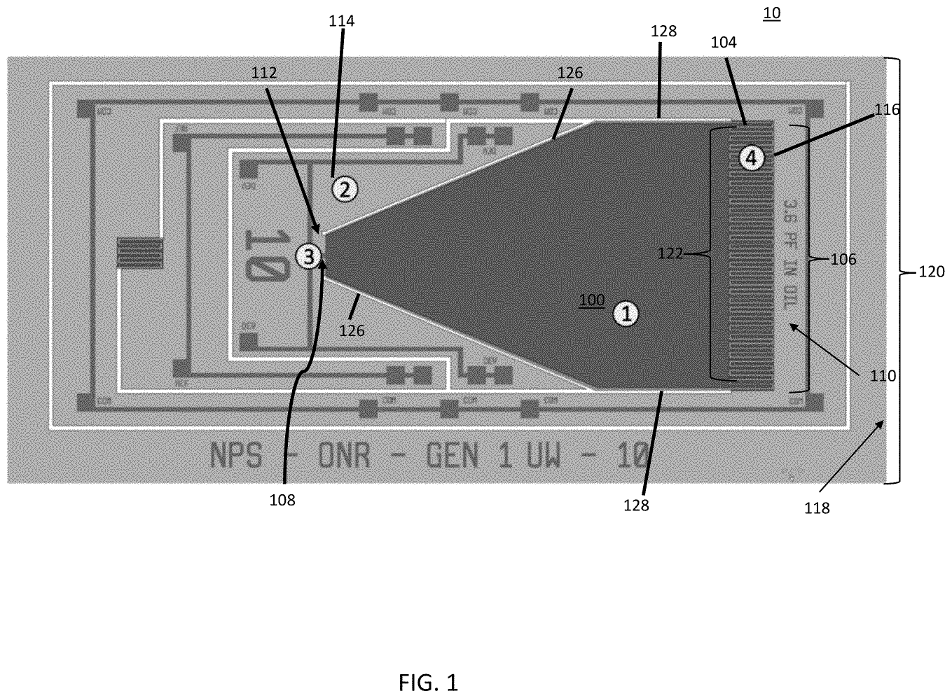

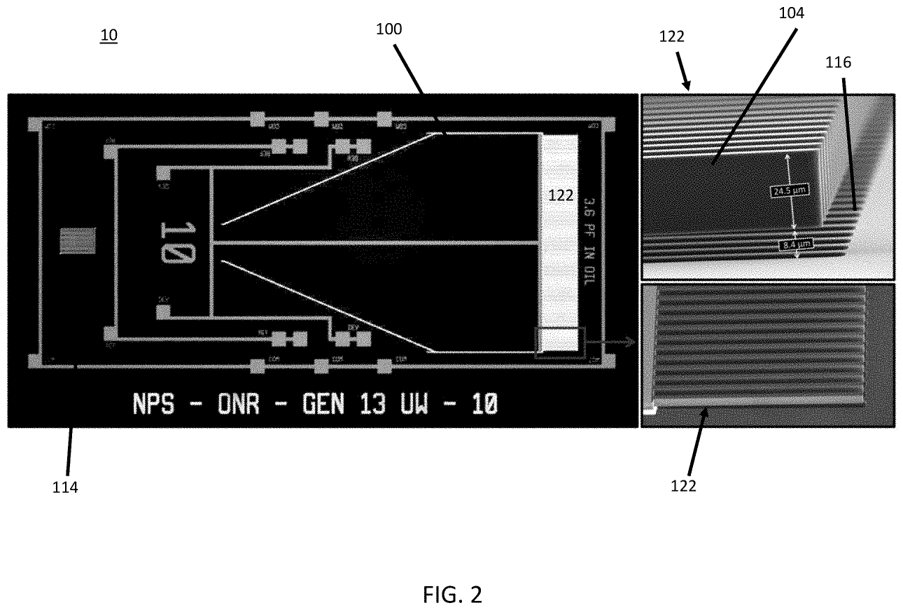

FIGS. 1 and 2 illustrate exemplary embodiments of an acoustic sensor assembly 10, which may be or include a microelectromechanical (MEMS) acoustic system or device configured for detecting sound excitation, such as responding to one or more sound waves. For example, as described in more detail below, acoustic sensor assembly 10 may be a monolithic MEMS device that can be placed in dielectric fluid to be used underwater, which provides a dipole directional response to incident sound. Acoustic sensor assembly 10 may include a sensor body 100 (shown at location 1 in FIG. 1) coupled to a substrate 114 (shown at location 2 in FIG. 1). For example, the substrate 114 may hold and/or support the sensor body 100.

Sensor body 100 may include a plurality of movable comb finger capacitors 104 extending along a width 106 of end 110 of the sensor body 100. The sensor body 100 may be winged-shaped, and may include sloping sides 126 each connecting at one side to end 112 of the sensor body 100 and connecting at the other side to lateral sides 128. Lateral sides 128 may each connect to end 110. Ends 110 and 112 may extend in a vertical direction, while lateral sides 128 may extend in a horizontal direction. In some embodiments, end 112 may be substantially wedge-shaped.

In some embodiments, sensor body 100 may have a mechanical structure and may have a thickness of about 20-30 μm thick (e.g., 24.5 μm as shown in the SEM micrograph in FIG. 2), 5 mm in length, and 3 mm in width. The sensor body may be made of a silicon-based material, such as single crystal silicon. The movable comb finger capacitors 104 may include fingers of about 100-1000 μm long and be about 2-10 μm wide with about a 2-10 μm gap between the fingers.

Substrate 114 may be a silicon-on-insulator (SOI) substrate. Substrate 114 may include or be coupled to a first plurality of fixed comb finger capacitors 116. Capacitors 116 may be coupled to the substrate at end 118 of the substrate and extending along a width 120 of the end 118 of the substrate. The fixed comb finger capacitors 116 may include fingers of about 100-1000 μm long and be about 2-10 μm wide fingers with about a 2-10 μm gap between the fingers.

The sensor body 100 may be coupled to the substrate 114 at a pivot point surface 108 (shown at location 3 in FIG. 1). In some embodiments, the pivot point surface 108 may be an attachment point having a connecting structure for attaching to the substrate 114 and/or to the sensor body 100. The sensor body 100 may lie substantially in the same plane as the substrate 114 such that the first plurality of fixed comb finger capacitors 116 and the first plurality of movable comb finger capacitors 104 may form a set of interdigitated comb finger capacitors 122 (as shown at location 4 in FIG. 1).

The sensor body 100 may pivot about the pivot point surface 108 responsive one or more sound waves incident on a surface of the sensor body 100, such as a top surface 103a or bottom surface 103b. In some embodiments, the pivoting of the sensor body 100 may cause movement of the movable capacitors 104 and may cause the set of interdigitated comb finger capacitors 122 to generate an electrical signal based on the amount of pivoting associated with the sensor body 100. In some embodiments, the electrical signal may be output to a voltage sensor.

FIG. 2 illustrates an SEM micrograph of an embodiment of acoustic sensor assembly 10. As shown in FIG. 2, in one example, the movable capacitors 104 may be slightly displaced with that of the substrate 114 and/or fixed capacitors 116. This displacement may be due to the residual stress-induced tilting of the sensor body 100 when released from the substrate 114 after the fabrication. In some embodiments, displacement can reduce the overall capacitance between the movable capacitors 104 and the fixed capacitors 116, impacting the electronic readout or signal produced by the interdigitated comb finger capacitors 122. In some embodiments, there may be a more reduced or no overlap of the movable capacitors 104 and the fixed capacitors 116, such as due to the fabrication. For example, as shown in FIG. 2, there may be a vertical gap between the movable capacitors 104 and the fixed capacitors 116 of about 8.4 micrometers due to fabrication. In such cases, there the interdigitated comb finger capacitors 122 may still produce an electrical signal.

Acoustic sensor assembly 10 may be configured to operate when submerged in a first fluid (e.g., silicone oil) contained in and sealed inside of a housing that may be submerged in a second fluid (e.g., water). In some embodiments, the acoustic sensor assembly 10 may detect sounds waves propagating through the second fluid from a source. The acoustic sensor assembly 10 may oscillate back and forth and may provide a directional response and a frequency response, such as described below in more detail.

According to some aspects, acoustic sensor assembly 10 may oscillate at or about a resonant frequency (and/or in a frequency band around the resonance frequency) about the pivot point surface 108. In some embodiments, the mechanical motion of acoustic sensor assembly 10 may follow or be similar to operation of a mass on a spring in mechanics theory with the following relationship:

k/m=ω²

where k=spring constant, m=mass, and ω=resonant frequency.

In some embodiments, the stiffness or associated mechanical characteristic of the pivot point surface 108 (i.e., support structure, bridge, arm(s), etc.) might influence the resonant frequency. According to some aspects, the stiffness or associated mechanical characteristic of the pivot point surface 108 may be related to the spring constant, such as in the above equation.

In some embodiments, the sensor body 100 may be fabricated using MEMSCAP® foundry service. See Downey, R. H.; Karunasiri, G. Reduced residual stress curvature and branched comb fingers increase sensitivity of MEMS acoustic sensor. J. Microelectromechanical Syst. 2014, 23, 417-423. [CrossRef]. This may result in a relatively longer wing employed in the design in the single sing embodiment (as compared to a multi-wing embodiment, such as describe below in more detail) to meet the MEMSCAP® design rules. In a single wing embodiment, the sensor body 100 may oscillate in a bending mode (as opposed to both a bending mode and a rocking mode as with a multi-wing embodiment, again described below in more detail).

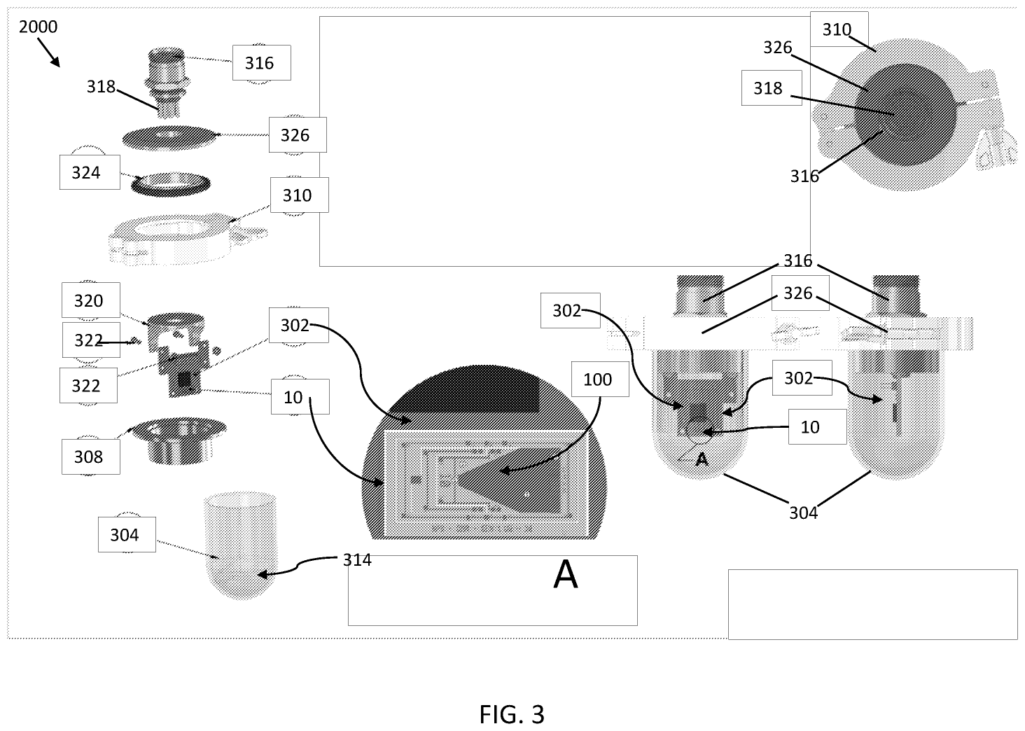

FIG. 3 illustrates schematics of various views an embodiment of a MEMS acoustic assembly 2000 including acoustic sensor assembly 10. As shown, the acoustic sensor assembly 10 may be coupled to and/or bonded to a board 302 (e.g., a printed circuit board or PCB), which may be an off-the-shelf board or may be a specially configured board. The board 302 may be coupled to a board holder 320, which may be attached and/or held via screws 322 by a board holder 320 having two arms extending from a circular ring portion. The board holder may be attached to a flange assembly 308.

The circular ring portion of the board holder 320 and flange 308 may fit into and/or be coupled to a center ring 324, which may fit inside of and/or be coupled to a clamp 310. A bulkhead 316 may extend through a center hole of an upper metallic plate 326 that may be fit and connected to a top side of clamp 310 and center ring 324 forming a tight seal. The bulkhead 316 may include a bulkhead connector 318 (e.g., a 12-pin underwater connector) which may extend through the holes of plate 326, center ring 324, clamp 310, flange 308 and the circular ring portion of the board holder 320. The bulkhead connector 318 may connect to the board 320.

Board 320 and acoustic sensor assembly 10 may be submerged in a cavity formed in a housing of a boot assembly 304. According to some aspects, the boot assembly 304 may have a housing forming a vessel (and cavity inside the vessel) configured to hold a fluid 314, such as a dielectric fluid. Voltage generated by the acoustic sensor assembly 10 responsive to sound excitation may be output via board 302 (and/or other electrical components) and via wires in the bulkhead connector 318.

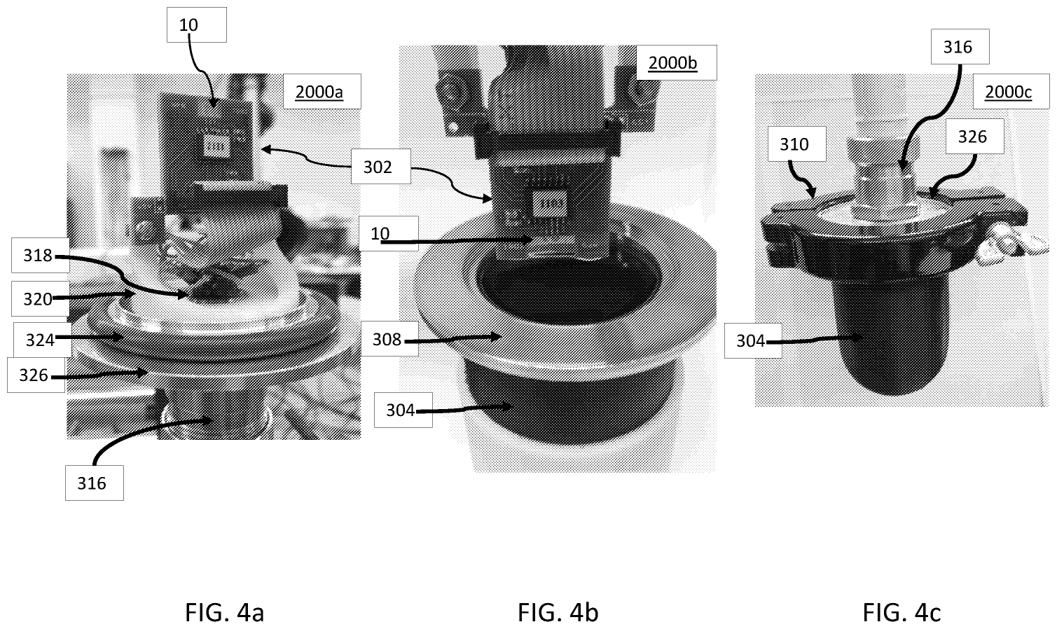

FIGS. 4a, 4b, and 4c illustrate an exemplary assembly of an embodiment of a MEMS acoustic system 2000a-c including acoustic sensor assembly 10. FIG. 4a shows acoustic sensor assembly 10 coupled to the board 302, which is attached to the bulkhead connector 318 and board holder 320. The board holder 320 is coupled to the center ring 320.

FIG. 4b shows the board 302 being lowered into the cavity of the vessel of the boot assembly 304. The flange 308 may be fitted on the top surface of the housing of the boot assembly 304. The vessel of the boot assembly 304 may be filled with fluid 314, which may be a dielectric fluid.

FIG. 4c shows the sealed system 2000 having the bulkhead cable extending out from bulkhead 316 and plate 326. The clamp 310 may be closed or tightened using any means such that the acoustic sensor assembly 10 is completely sealed inside of the boot assembly 304, containing the fluid 314, the board 302, and the acoustic sensor assembly 10. The fluid 314 inside of the boot assembly 304 may be substantially free of any gas or bubbles.

### Example 1

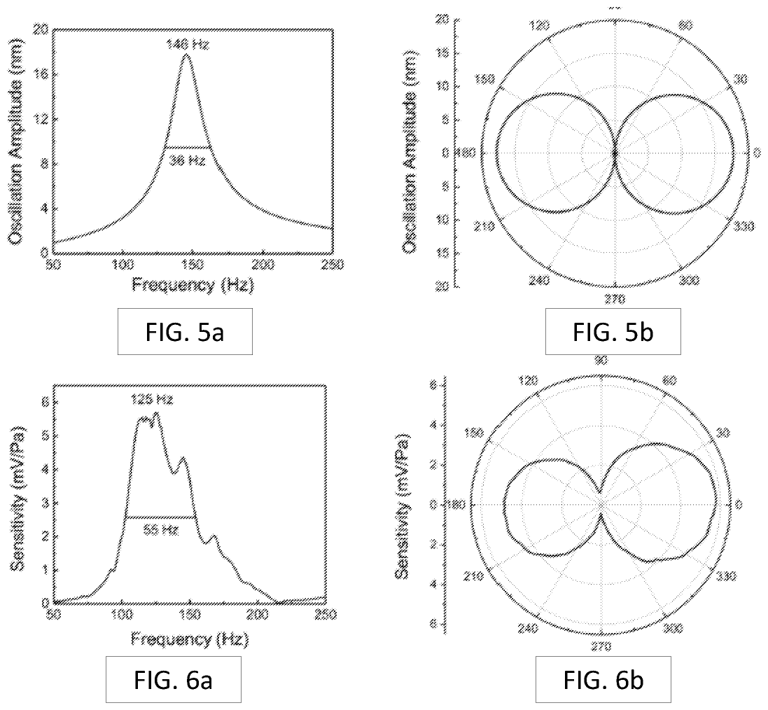

FIGS. 5a and 5b illustrate exemplary response plots of simulated frequency (FIG. 5a) and directional (FIG. 5b) responses of the acoustic assembly 2000. In the example, the mechanical structure of the sensor 10 is about 25 μm thick and made of single crystal silicon. The interdigitated comb finger capacitors 122 are about 500 μm long, where each capacitor is about 10 μm wide, with about a 10 μm gap between each capacitor. The interdigitated comb finger capacitors 122 are located at the edge of the wing sensor body 100 for electronic readout of the oscillation amplitude under sound excitation.

FIG. 5a shows a plot of the simulated frequency response of the sensor 10. In this example, the frequency response was obtained using COMSOL Multiphysics® finite element (FE) modeling. The simulation was performed with the sensor 10 immersed in low-viscosity (1cSt) silicone oil. The acoustic impedance of silicone oil is close to that of the water (about 1.48 MPa.s.m₋₁). The modeling was carried out with the help of Pressure Acoustic, Thermoviscous Acoustic, and Structural Mechanics modules of COMSOL. Incident sound wave amplitude was set to 1 Pa in the simulation. No fitting parameters were used in the simulation and the damping was generated by interaction of the mechanical structure with the fluid. A resonant peak frequency was found at approximately 146 Hz compared to about 880 Hz when simulated in air. Frequency reduction in oil is primarily due to the higher density (818 kg/m₃) of oil compared to that of air.

According to disclosed aspects, the response of the acoustic sensor assembly 10 is controllable by design depending on any number of factors, such as range. For example, the acoustic sensor assembly 10 may be designed for a specific frequency response (e.g., a specific resonant peak and/or FWHM, discussed below) depending on the mass of the sensor body 100, string constant, viscosity of fluid 314, and the like. For example, the higher the viscosity of fluid 314, the higher the amount of mass (i.e., mass of the fluid) is moved when sensor body 100 oscillates due to the contact and drag provided by the higher viscous fluid 314 on the sensor body 100 in side of boot assembly 304. That is, a fluid 314 with higher viscosity may provide a lower resonant frequency, because there may more mass of the oil moving back and forth with the oscillation.

According to some aspects, the characteristics of the pivot point surface 108 may influence the spring constant, which may change the resonant frequency. For example, the size, width, length, etc. of the pivot point surface 108, which may be a bar or bridge, may affect the spring constant. Sound incident on the pivot point surface 108 may vibrate the surface 108. According to some aspects, the wider or shorter the bridge, the larger the resonant frequency. Likewise, the narrower or longer the bridge, the lower the resonant frequency.

Acoustic sensor assembly 10 and/or sensor body 100 may be specifically designed control the resonant sequence and the width of the character response. For example, by modifying the mechanical structure or characteristics of one or more components of acoustic sensor assembly 10 (e.g., designing a component as wider, longer, etc.), the frequency response can be modified and/or optimized, such as for a specific application.

FIG. 5b shows a plot of the simulated directional response (oscillation amplitude at different angles) of the sensor 10 at the simulated resonant peak frequency (e.g., 146 Hz from FIG. 5a) showing a cosine dependence of the amplitude of vibration with direction of sound, as represented by:

P=|αP₀cos θ|

where P is a sensor readout reporting displacement of the wings relative to the support, α is a normalization constant applied according to sensor baseline readings, P₀ is the amplitude of the incoming sound pressure, and θ is the direction of arrival with respect to a normal, such as described in U.S. Pat. No. 9,843,858, herein incorporated by reference in its entirety. The cosine dependence indicates that if the sound wave is of normal incidence (e.g., perpendicular on a flat surface of the sensor body 100), the generated signal will be a maximum value. If the sound wave is of 90 degrees, the generated signal goes to zero.

FIGS. 6a and 6b illustrate exemplary response plots of measured frequency (FIG. 5a) and directional (FIG. 5b) responses of the acoustic assembly 2000 submerged in water. The fluid 314 inside of the cavity 312 of the boot 304 is a non-conducting fluid with low viscosity. For example, 1cSt silicone oil was used in this example, but a dielectric type fluid that is non-conductive that has a viscosity close to or substantially equal to water may be used so that the impedance is not disturbed. In some embodiments, deionized water or castor oil may be used as the fluid 314.

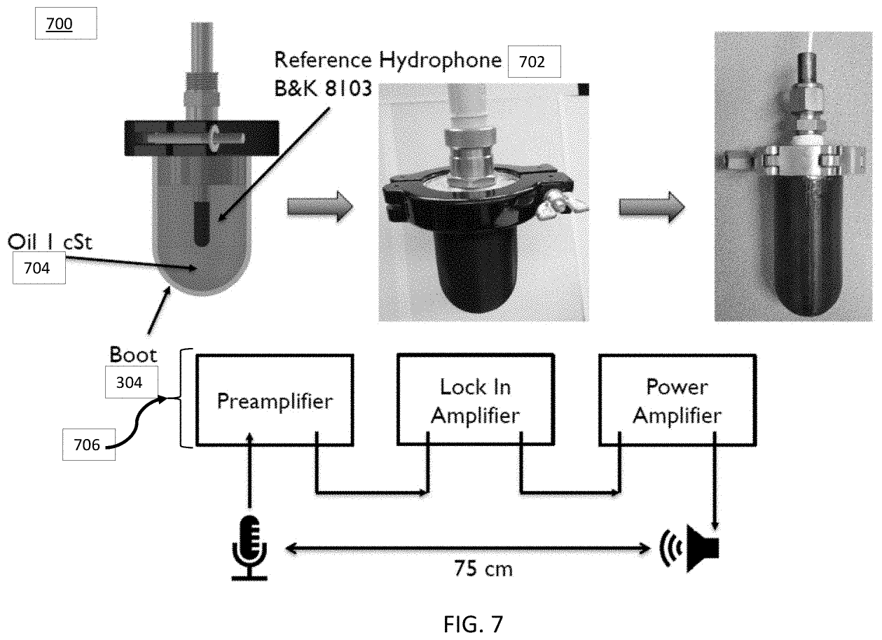

The housing of boot assembly 304 may be made of a material, such as rubber (e.g., PMC-780 polyurethane). The material of the housing of boot assembly 304 and the type of fluid 314 may be chosen to allow sound waves to travel through the boot assembly 304 and the fluid 314 with near unity acoustic transmission. FIGS. 7-9 show a calibration system and associated results for determining the acoustic transmission properties for material of the housing of boot assembly 304 and the type of fluid 314 to enable a near unity of acoustic transmission for acoustic assembly 2000.

For example, FIG. 7 illustrates a calibration system 700 that includes a calibrated reference hydrophone 702. With respect to FIG. 7, the acoustic transmission characteristics of the PMC-780 polyurethane boot assembly 304 filled with silicone oil 704 enclosing the hydrophone 702 was determined by measuring the response of the calibrated reference hydrophone 702, which may be B&K 8103. The system 700 can include, for example, electronics 706 (e.g., a preamplifier, a lock in amplifier, a power amplifier, and the like), which may be used to measure the response. According to some aspects, one or more components of system 700 may be used with the devices and embodiments disclosed herein and show in associated figures.

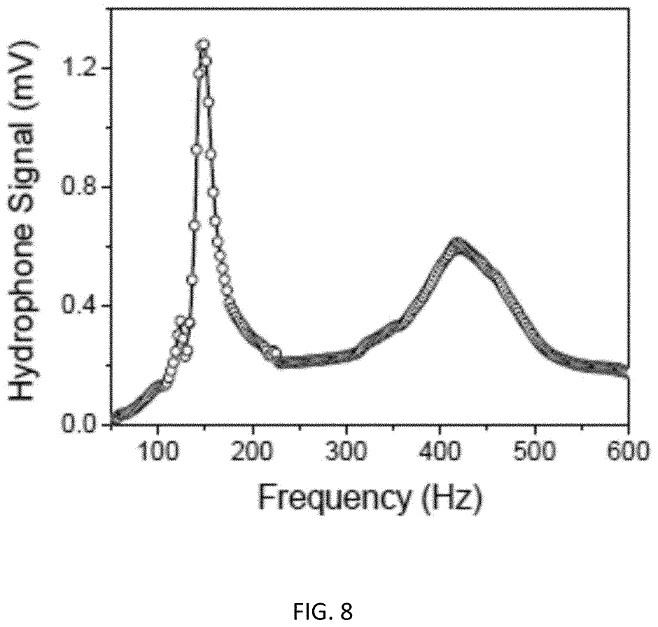

FIG. 8 illustrates a plot of the signal measured from the reference hydrophone 702 and PMC-780 polyurethane boot assembly 304, with the solid line indicating the signal of the hydrophone 702 placed outside of the boot assembly 304, and the circles indicating the signal of the hydrophone 702 placed inside of the boot assembly 304. The data indicates no appreciable difference between these two responses. This indicates a near unity transmission coefficient through the PMC-780 polyurethane boot assembly 304 filled with silicone oil. It is noted that the resonant peaks in FIG. 8 are associated with characteristics of the projector system used in the system of FIG. 7.

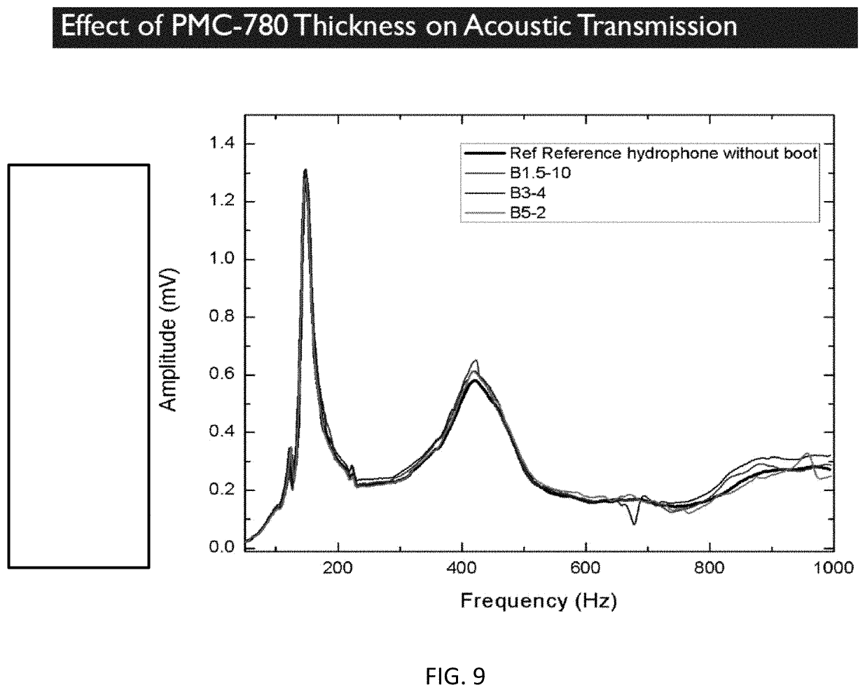

FIGS. 9 illustrates a plot of responses of different thicknesses used for the housing of a PMC-780 polyurethane boot assembly 304. For example, thicknesses of 1.5, 3, and 5 mm were measured against the measurement of the reference hydrophone 702 without a boot assembly 304. As shown in FIG. 9, there are negligible variations of frequency response when using PMC-780 between the four thicknesses, suggesting that PMC-780 is an acoustically transparent material, with even a varying thickness of PMC-780 material used for the housing using silicone oil.

Other types of rubber material may be used for the housing of boot assembly 304, as well as other types of fluid may be used as fluid 314. As stated above, the material of the housing of boot assembly 304 and the type of fluid 314 may be chosen to allow sound waves to travel through the boot assembly 304 and the fluid 314 with near unity acoustic transmission, such as shown in the plots of FIGS. 8 and 9.

Referring back to FIGS. 6a and 6b, the measurements of assembly 2000 were made using a PMC-780 polyurethane boot assembly 304. During the characterization, assembly 2000 was suspended in a tank of water at about 2 meters away from the sound projector at a depth of about 6 meters. A calibrated hydrophone was co-located with the acoustic sensor assembly 10 to provide the sound pressure. The measured sensitivity (mV/Pa) of the acoustic sensor assembly 10 over the frequency range 50-250 Hz is shown in FIG. 6a. The peak sensitivity was found to be about 5.5 mV/Pa or −165 dB re 1 V/μPa.

As compared to the simulated resonant peak of FIG. 5a, the measured resonant peak in FIG. 6a is about 20% lower. The measured full width at half maximum (FWHM) is about 55 Hz compared to about 40 Hz obtained from the simulation without using any adjustable parameters in FIG. 5a. The FWHM may be the operational bandwidth of acoustic sensor assembly 10. The FWHM may be a frequency band based around the resonant frequency. According to some aspects, drag from the sensor body 100 and fluid flow between comb fingers 122 (Couette flow) may contribute to damping. See Klose, T.; Conrad, H.; Sandner, T.; Schenk, H. Fluid-mechanical Damping Analysis of Resonant Micromirrors with Out-of-plane Comb Drive. In Proceedings of the COMSOL Conference, Hanover, Germany, 4-6 Nov. 2008.

As compared to the simulated directional response of FIG. 5b, the measured directional response of the sensor is measured at the peak measured frequency of 125 Hz and shown in the polar plot of FIG. 6b. The directional response in FIG. 6b shows the expected cosine dependence and agrees well with the predicted response. It is noted that the slight asymmetry of the measured directional response pattern is most likely to be due to the effect of the housing flange and clamp during the measurement.

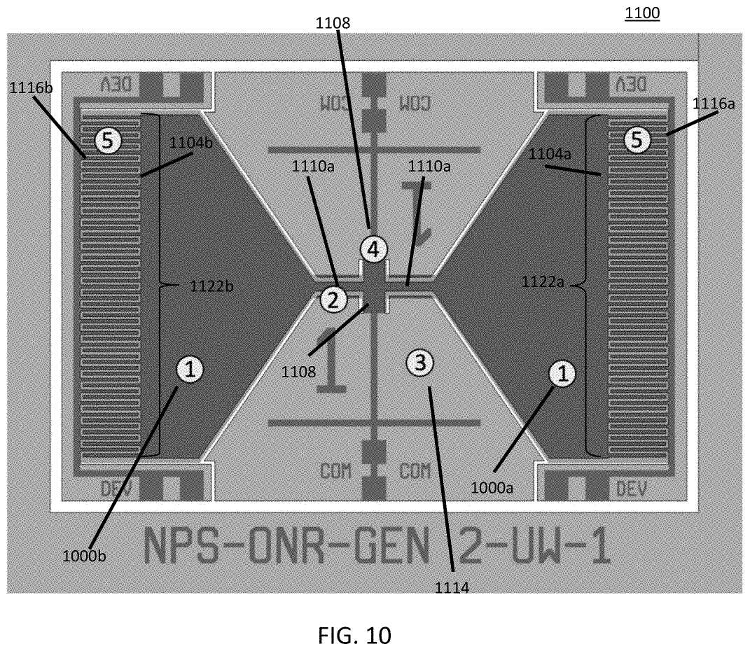

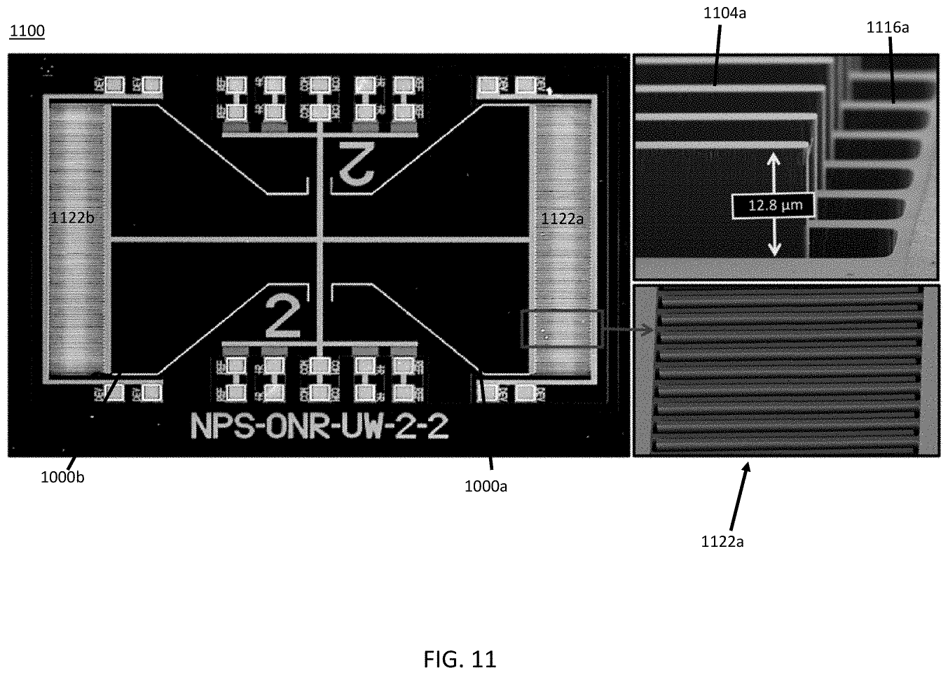

FIGS. 10 and 11 illustrate exemplary embodiments of an acoustic sensor assembly 1100, which may be or include a microelectromechanical (MEMS) acoustic system or device configured for detecting sound excitation, such as responding to one or more sound waves. Shortening the length of the wing can allow the comb fingers to overlap; however this may cause an undesirable reduction on the oscillation amplitude. This loss of oscillation amplitude can be compensated by adding additional wings, such as providing a plurality of reduced-length wings (e.g., 2 wings, or more), as compared with a single-wing embodiment, as sensor bodies, thus allowing the comb fingers to overlap. See Wilmott, D.; Alves, F.; Karunasiri, G. Bio-Inspired Miniature Directional Finding Acoustic Sensor. Sci. Rep. 2016, 6, 29957. [CrossRef].

FIGS. 10 and 11 show an embodiment of a two-wing MEMS sensor design for operating in underwater applications. FIG. 11 illustrates an SEM micrograph of an embodiment of acoustic sensor assembly 1100. Assembly 1100 may be a monolithic MEMS device that can be placed in dielectric fluid to be used underwater, which provides a dipole directional response to incident sound using the two wing sensors. Components of assembly 1100 may include parts similar to or the same as acoustic sensor assembly 10, as shown in FIGS. 1 and 2, and assembly 1100 may be integrated into a microelectromechanical system, such as disclosed herein (e.g., as described with respect to FIGS. 3 and 4 with the single-wing embodiment).

Assembly 1100 may include a first sensor body 1000a and a second sensor body 1000b (shown at locations 1 in FIG. 10) both coupled to a substrate 1114 (shown at location 3 in FIG. 10). Sensor bodies 1000a and 1000b may be wing-shaped and may be substantially similar to sensor body 100 described in FIG. 1, but one or both may have varying dimensions as sensor body 100 (and from one another). Sensor bodies 1000a and 1000b may be coupled at pivot point surface 1108 (shown at location 4 in FIG. 10) to each other (and/or to substrate 1114) via a bridge assembly 1112 via respective legs 1110a and 1110b (shown at location 2 in FIG. 10).

Sensor bodies 1000a and 1000b may lie substantially in the same plane as the substrate 1114 such that a first plurality of fixed comb finger capacitors 1116a, 1116b and the first plurality of movable comb finger capacitors 1104a, 1104b may form sets of interdigitated comb finger capacitors 1122a, 1122b. The sensor bodies 1000a and 1000b may pivot about the pivot point surface 1108 responsive one or more sound waves incident on a surface of each sensor body 1000a and 1000b. In some embodiments, the pivoting of the sensor bodies 1000a and 1000b may cause movement of the movable capacitors 1104a, 1104b and may cause the one or more of the sets of interdigitated comb finger capacitors 1122a, 1122b to generate one or more electrical signals based on the amount of pivoting associated with the respective sensor body 1000a, 1000b. In some embodiments, the interdigitated comb finger capacitors 1122a, 1122b may be connected in parallel in order to increase the electronic response.

As stated above, with respect to FIGS. 1 and 2, due to the manufacturing, in some embodiments, there may be a lack of overlap between the fixed and movable comb fingers due to the use of a relatively long wing body for the sensor body 100. The longer wing provides larger oscillation amplitude which can generate a stronger electrical signal; however the lack of overlap between the comb fingers (see FIG. 2) may reduce the amount of capacitance change under sound excitation, resulting in a smaller electronic signal. See Touse, M.; Sinibaldi, J.; Simsek, K.; Catterlin, J.; Harrison, S.; Karunasiri, G. Fabrication of a microelectromechanical directional sound sensor with electronic readout using comb fingers. Appl. Phys. Lett. 2010, 96, 173701. [CrossRef].

Accordingly, in one embodiment, the length of each wing sensor body may be reduced from 5 mm (FIGS. 1 and 2) to 2.5 mm (FIGS. 10 and 11) and the gap between comb fingers may be reduced from 10 μm (FIGS. 1 and 2) to 5 μm (FIGS. 10 and 11). The reduction of the gap acts to enhance the mechanical to electrical transduction due to increased capacitance. Note that the reduced gap acts to increase the component of damping generated by these structures, which in turn could reduce the oscillation amplitude. Nevertheless, it was found in simulation that the main contribution to damping comes from the drag which depends on the area of the wings. Both modes, rocking and bending, are available with a multi-winged embodiment.

Assembly 1100 may be fitted in an acoustic assembly similar to MEMS acoustic system 2000 for underwater use.

### Example 2

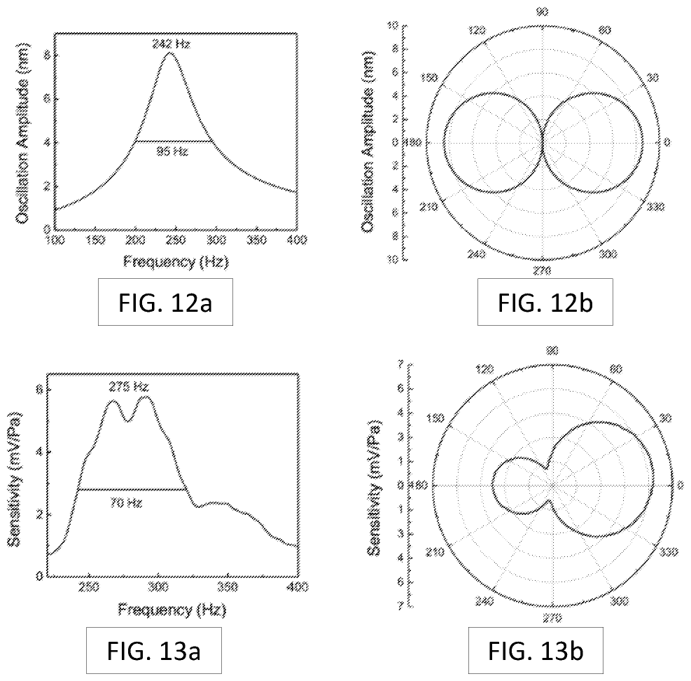

Similar to FIGS. 5a and 5b, FIGS. 12a and 12b illustrate exemplary response plots of simulated frequency (FIG. 12a) and directional (FIG. 12b) responses of assembly 1100 fitted and sealed in an acoustic assembly similar to MEMS acoustic system 2000. The simulation for FIGS. 12a and 12b uses similar conditions and setup as FIGS. 5a and 5b. As before, the simulation was performed by immersing the sensor in silicone oil. Incident sound wave amplitude was kept at 1 Pa.

The bending resonant peak of the two-winged assembly 1100 was found to be around 242 Hz and the simulated directional response at resonance showed the expected cosine behavior. The FWHM was about 95 Hz which is higher than that obtained for the single wing configuration. This may be due to the use of smaller gap between comb fingers in the two-wing configuration since total area of the wings was close to that of the single wing design in these examples.

The oscillation or pivoting of sensor bodies 1000a and 1000b may cause movement of the set of interdigitated comb finger capacitors 1022a and 1022b to generate one or more electrical signals based on the amount of pivoting associated with the sensor body 100.

The directional response, shown in FIG. 12b, was simulated at 242 Hz (bending resonant frequency), and showed the cosine dependent directional response.

Similar to FIGS. 6a and 6b, FIGS. 13a and 13b illustrate exemplary response plots of measured frequency (FIG. 13a) and directional (FIG. 13b) responses of assembly 1100 fitted in an acoustic assembly similar to MEMS acoustic system 2000 submerged in water. Conditions and/or components may be the same or similar to those used with respect to FIGS. 6a and 6b. The fluid 314 inside of the cavity 312 of the boot 304 may be a non-conducting fluid with low viscosity (e.g., Silicone oil) and the boot assembly 304 may be made of a rubber material (e.g., PMC-780 polyurethane). The material of the housing of boot assembly 304 and the type of fluid 314 may be chosen to allow sound waves to travel through the boot assembly 304 and the fluid 314 with near unity acoustic transmission, such as described above with respect to FIGS. 7-9.

Frequency responses of the sensor assembly 1100 and a reference hydrophone were measured simultaneously from 220 to 400 Hz by placing them at equal distances from the sound projector. The measured sensitivity (mV/Pa) of the sensor assembly 1100 is shown in FIG. 13a. A relatively broad resonant peak centered around 275 Hz can be observed with maximum sensitivity of about 6 mV/Pa or −165 dB re 1 V/μPa. The increased bandwidth, compared to that of the single wing sensor embodiment, might arise from additional damping generated by the second wing with combs as well as a smaller gap between the comb fingers.

Note that in spite of the broader response in this embodiment, the sensitivity at the resonant peak is similar to that measured for the single wing sensor embodiment. This can be explained by the increased electrical signal generated by the overlap of comb fingers (such an overlap can be shown in FIG. 11). As compared to the simulated resonant peak of FIG. 12a, the simulated resonant peak shown is found to be about 10% below that of the measured sensor.

The directional response of the MEMS sensor was measured by rotating it at the peak frequency of 275 Hz. The directivity pattern at 275 Hz is shown in FIG. 13b, giving an asymmetric figure eight directivity pattern. Again, the asymmetric response is most likely to be due to the flange and clamp that have asymmetric configurations. A general cosine response, however, is observable.

MEMS-based devices for underwater application have been described. Although particular embodiments, aspects, and features have been described and illustrated, one skilled in the art would readily appreciate that the aspects described herein is not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

What is claimed is:

1. A microelectromechanical system configured to be submerged in a fluid comprising:
an acoustic sensor assembly comprising:
a substrate;
a first plurality of fixed comb finger capacitors coupled to the substrate at a first end of the substrate and extending along a width of the first end of the substrate;
a second plurality of fixed comb finger capacitors coupled to the substrate at a second end of the substrate and extending along a width of the second end of the substrate;
a first sensor wing;
a second sensor wing coupled to the first sensor wing by a bridge assembly attached to the substrate;
a first plurality of movable comb finger capacitors extending along a width of a first end of the first sensor wing, the first plurality of fixed comb finger capacitors and the first plurality of movable comb finger capacitors being a first set of interdigitated comb finger capacitors; and
a second plurality of movable comb finger capacitors extending along a width of a second end of the second sensor wing, the second plurality of fixed comb finger capacitors and the second plurality of movable comb finger capacitors being a second set of interdigitated comb finger capacitors;
a boot assembly having a cavity being configured to contain dielectric fluid and to enclose the acoustic sensor assembly, wherein the acoustic sensor assembly is communicably coupled to the dielectric fluid and boot, the acoustic sensor assembly being configured to receive the one or more sound waves from a source through the boot and dielectric fluid with near unity acoustic transmission; and
a flange assembly disposed at a top side of the boot assembly and configured to cover and seal the acoustic sensor assembly and the dielectric fluid in the boot assembly.

2. The microelectromechanical system of claim 1, wherein the acoustic sensor assembly further comprises two legs attached to the bridge on either side of the bridge and connected to the substrate, wherein the first sensor wing is coupled to a first of the two legs, and the second sensor wing is coupled to the second of the two legs.

3. The microelectromechanical system of claim 2, wherein:
the first sensor wing is configured to pivot about the bridge assembly by twisting the first leg in responsive to one or more sound waves incident on a first surface of the first sensor wing, wherein pivoting causes the first set of interdigitated comb finger capacitors to generate a first electrical signal based on an amount of pivoting associated with the first sensor wing; and
the second sensor wing is configured to pivot by twisting the second leg in responsive to one or more sound waves incident on a first surface of the second sensor wing, wherein the pivoting causes the second set of interdigitated comb finger capacitors to generate a second electrical signal based on an amount of pivoting associated with the second sensor wing.

4. The microelectromechanical system of claim 1, wherein the acoustic sensor assembly is attached at a bottom side of the flange assembly.

5. The microelectromechanical system of claim 1, wherein the acoustic sensor assembly is configured to optimally operate in a frequency band based around a resonant frequency associated with the acoustic sensor assembly.

6. The microelectromechanical system of claim 5, wherein a mass of the acoustic sensor assembly is inversely related to the resonant frequency associated with the acoustic sensor assembly.

7. The microelectromechanical system of claim 5, wherein the resonant frequency associated with the acoustic sensor assembly is based on mass or viscosity of the dielectric fluid.

8. The microelectromechanical system of claim 1, wherein a directional response of the acoustic sensor assembly is based on a direction of sound incident on at least the first sensor wing or the second sensor wing, such that the generated first electrical signal or the second electrical signal has increased sensitivity responsive to one or more sound waves being more perpendicularly incident on a first surface of the first sensor wing or a first surface of the second sensor wing.

9. The microelectromechanical system of claim 1, wherein the dielectric fluid comprises a silicone-based oil.

10. The microelectromechanical system of claim 1, wherein the boot assembly comprises a rubber material.

11. A microelectromechanical system configured to be submerged in a fluid comprising:
an acoustic sensor assembly comprising:
a substrate;
a first plurality of fixed comb finger capacitors coupled to the substrate at a first end of the substrate and extending along a width of the first end of the substrate; and
a first sensor body and a first plurality of movable comb finger capacitors extending along a width of a first end of the first sensor body, the first sensor body being coupled to the substrate at a pivot point surface, the first plurality of fixed comb finger capacitors and the first plurality of movable comb finger capacitors being a set of interdigitated comb finger capacitors, wherein the first sensor body is configured to pivot about the pivot point surface responsive one or more sound waves incident on a first surface of the first sensor body, wherein the pivoting causes the set of interdigitated comb finger capacitors to generate an electrical signal based on an amount of pivoting associated with the first sensor body;
a boot assembly having a housing and a cavity formed in the housing and being configured to contain dielectric fluid and to enclose the acoustic sensor assembly, wherein the acoustic sensor assembly is communicably coupled to the dielectric fluid and the housing, the acoustic sensor assembly being configured to receive the one or more sound waves from a source through the housing and the dielectric fluid with near unity acoustic transmission; and
a flange assembly disposed at a top side of the boot assembly and configured to cover and seal the acoustic sensor assembly and the dielectric fluid in the boot assembly,
wherein the acoustic sensor assembly is configured to generate the electrical signal with (1) a maximum frequency response in a frequency band based around a resonant frequency associated with the acoustic sensor assembly and (2) a cosine dependent directional response.

12. The microelectromechanical system of claim 11, wherein the pivot point surface couples to the acoustic sensor assembly at a second end of the first sensor body.

13. The microelectromechanical system of claim 11, wherein the acoustic sensor assembly further comprises a second sensor body and a second plurality of movable comb finger capacitors extending along a width of a first end of the second sensor body.

14. The microelectromechanical system of claim 13, wherein a second end of the second sensor body is coupled to a second end of the first sensor body at the pivot point surface, the second sensor body configured to pivot about the pivot point independent of the first sensor body.

15. The microelectromechanical system of claim 14, further comprising a second plurality of fixed comb finger capacitors coupled to the substrate at a second end of the substrate and extending along a width of the second end of the substrate, the second plurality of fixed comb finger capacitors and the second plurality of movable comb finger capacitors being a second set of interdigitated comb finger capacitors, wherein pivoting of the second sensor body causes the second set of interdigitated comb fingers to generate a second electrical signal.

16. The microelectromechanical system of claim 14, wherein the pivot point surface comprises a bridge assembly connecting to the first sensor body and to the second sensor body.

17. The microelectromechanical system of claim 11, wherein the acoustic sensor assembly is attached at a bottom side of the flange assembly.

18. The microelectromechanical system of claim 11, wherein the frequency band comprises a full width at half maximum.

19. The microelectromechanical system of claim 11, wherein a mass of the acoustic sensor assembly is inversely related to the resonant frequency associated with the acoustic sensor assembly.

20. The microelectromechanical system of claim 11, wherein the resonant frequency associated with the acoustic sensor assembly is based on a viscosity or a mass of the dielectric fluid.

21. The microelectromechanical system of claim 11, wherein the directional response of the acoustic sensor assembly is based on a direction of sound incident on the first sensor body, such that the generated electrical signal has increased sensitivity responsive to one or more sound waves being more perpendicularly incident on the first surface of the sensor the first sensor body.

22. The microelectromechanical system of claim 11, wherein the dielectric fluid has an acoustic impedance value of about equal to the acoustic impedance value of water.

23. The microelectromechanical system of claim 11, wherein the dielectric fluid has an acoustic impedance value of about equal to the acoustic impedance value of the submerging fluid.

24. The microelectromechanical system of claim 11, wherein the dielectric fluid comprises a silicone-based oil.

25. The microelectromechanical system of claim 11, wherein the boot assembly comprises a rubber material.

26. A method of operating a microelectromechanical system configured to be submerged in a fluid comprising:
providing an acoustic sensor assembly, the acoustic sensor assembly comprising:
a substrate;
a first plurality of fixed comb finger capacitors coupled to the substrate at a first end of the substrate and extending along a width of the first end of the substrate;
a second plurality of fixed comb finger capacitors coupled to the substrate at a second end of the substrate and extending along a width of the second end of the substrate;
a first sensor wing;
a second sensor wing coupled to the first sensor wing by a bridge assembly attached to the substrate;
a first plurality of movable comb finger capacitors extending along a width of a first end of the first sensor wing, the first plurality of fixed comb finger capacitors and the first plurality of movable comb finger capacitors being a first set of interdigitated comb finger capacitors; and
a second plurality of movable comb finger capacitors extending along a width of a second end of the second sensor wing, the second plurality of fixed comb finger capacitors and the second plurality of movable comb finger capacitors being a second set of interdigitated comb finger capacitors;
providing a boot assembly having a cavity being configured to contain dielectric fluid and to enclose the acoustic sensor assembly, wherein the acoustic sensor assembly is communicably coupled to the dielectric fluid and boot, the acoustic sensor assembly being configured to receive the one or more sound waves from a source through the boot and dielectric fluid with near unity acoustic transmission;
providing a flange assembly disposed at a top side of the boot assembly and configured to cover and seal the acoustic sensor assembly and the dielectric fluid in the boot assembly; and
receiving, by the acoustic sensor assembly, the one or more sound waves from the source through the boot and dielectric fluid with near unity acoustic transmission.

27. The method of claim 26, further comprising:
generating a first electrical signal based on an amount of pivoting associated with the first sensor wing; and
generating a second electrical signal based on an amount of pivoting associated with the second sensor wing.

28. The method of claim 26, further comprising
filling the boot assembly with the dialectic fluid;
enclosing the acoustic sensor assembly in the boot assembly;
covering the acoustic sensor assembly and the dielectric fluid in the boot assembly; and
sealing the acoustic sensor assembly and the dielectric fluid in the boot assembly.
